(19) United States
(12) Patent Application Publication
(10) Pub. No.: US 2025/0206394 A1
(43) Pub. Date: Jun. 26, 2025

(54) JIG

(71) Applicant: YAZAKI CORPORATION, Tokyo (JP)

(72) Inventors: Shohei Oka, Makinohara-shi (JP); Takeshi Ishikawa, Makinohara-shi (JP); Akinori Nakashima, Makinohara-shi (JP)

(21) Appl. No.: 18/970,887

(22) Filed: Dec. 5, 2024

(30) Foreign Application Priority Data
Dec. 26, 2023 (JP) 2023-219086

(51) Int. Cl. B62D 65/02; B60R 16/02; H02G 1/08

(52) U.S. Cl. CPC B62D 65/026; B60R 16/0215; H02G 1/085

(57) ABSTRACT

A jig includes a pair of side walls and a bottom wall, the pair of side walls is configured such that the other end portions in a height direction can be inserted into a routing space portion of an attachment member via a slit provided in an outer wall of the attachment member, the bottom wall and the pair of side walls are formed in a tapered shape, and a first cut portion extending along the height direction across the bottom wall and the other end portions of the pair of side walls in the height direction as viewed from a width direction is provided on the other end portion side in the axial direction.

### CROSS-REFERENCE TO RELATED APPLICATION(S)

The present application claims priority to and incorporates by reference the entire contents of Japanese Patent Application No. 2023-219086 filed in Japan on Dec. 26, 2023.

### BACKGROUND OF THE INVENTION

### 1. Field of the Invention

The present invention relates to a jig.

### 2. Description of the Related Art

As a technique related to a conventional jig, for example, Japanese Patent Application Laid-open No. H7-245840 A discloses a corrugated tube attachment jig including a pair of side walls holding an electric wire bundle, and a bottom wall coupling one end portions of the pair of side walls in a height direction and extending in an arc shape along an outer peripheral surface of the electric wire bundle.

By the way, in this type of jig, for example, there is a case where the jig is used when the electric wire bundle is inserted into a routing space portion of an attachment member through a slit provided in an outer wall of the attachment member, and in this case, there is room for further improvement in terms of improvement in workability of attachment work.

### SUMMARY OF THE INVENTION

The present invention has been made in view of the above circumstances, and an object is to provide a jig capable of improving workability of attachment work.

In order to achieve the above mentioned object, a jig according to one aspect of the present invention includes a pair of side walls that holds an electric wire bundle in which a plurality of electric wires extending along an axial direction is bundled from both sides in a width direction intersecting the axial direction; and a bottom wall that extends in an arc shape along an outer peripheral surface of the electric wire bundle and couples one end portions of the pair of side walls in a height direction intersecting the axial direction and the width direction, wherein the pair of side walls is configured such that other end portions in the height direction can be inserted into a routing space portion of an attachment member through a slit provided in an outer wall of the attachment member, and the bottom wall and the pair of side walls are formed in a tapered shape in which the bottom wall is inclined so as to gradually approach the other end portions of the pair of side walls in the height direction from one end portion side to an other end portion side in the axial direction, and a first cut portion extending along the height direction across the bottom wall and the other end portions of the pair of side walls in the height direction as viewed from the width direction is provided on the other end portion side in the axial direction.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exemplary perspective view of a vehicle to which a wire harness assembly according to an embodiment is applied;

FIG. 2 is an exemplary cross-sectional view of the wire harness assembly to which a jig according to the embodiment is applied;

FIG. 3 is an exemplary perspective view of a body member of the wire harness assembly according to the embodiment;

FIG. 4 is an exemplary plan view of the vicinity of a wide portion of a slit of the wire harness assembly according to the embodiment;

FIG. 5 is an exemplary perspective view of the wire harness according to the embodiment;

FIG. 6 is an exemplary cross-sectional view of a binding posture maintaining portion of the wire harness according to the embodiment;

FIG. 7 is an exemplary cross-sectional view of a binding posture variable portion of the wire harness according to the embodiment;

FIG. 8 is an exemplary exploded perspective view of the wire harness assembly according to the embodiment;

FIG. 9 is an exemplary perspective view of a jig according to the embodiment;

FIG. 10 is an exemplary side view of the jig according to the embodiment;

FIG. 11 is an exemplary flowchart of a method for manufacturing the wire harness assembly according to the embodiment;

FIG. 12 is an exemplary perspective view of the wire harness assembly according to the embodiment and is a view illustrating a first step;

FIG. 13 is an exemplary perspective view of the wire harness assembly according to the embodiment and is a view illustrating a second step;

FIG. 14 is an exemplary perspective view of the wire harness assembly according to the embodiment and is a view illustrating a third step;

FIG. 15 is an exemplary perspective view of the wire harness assembly according to the embodiment and is a view illustrating a fourth step;

FIG. 16 is an exemplary perspective view of a wire harness according to a modification; and

FIG. 17 is an exemplary cross-sectional view of a binding posture variable portion of the wire harness according to the modification.

### DETAILED DESCRIPTION OF THE PREFERRED EMBODIMENTS

Hereinafter, an embodiment and a modification according to the present invention will be described in detail with reference to the drawings. Note that this invention is not limited to the embodiment and the modification described below. In addition, constituent elements in the embodiment and the modification described below include those that can be easily replaced by those skilled in the art or those that are substantially the same.

In addition, the embodiment and the modification disclosed below include similar constituent elements. Therefore, in the following description, common reference numerals are given to these similar constituent elements, and redundant description will be omitted. Note that, in the present specification, ordinal numbers are used only to distinguish components, members, parts, positions, directions, and the like, and do not indicate order or priority.

### Embodiment

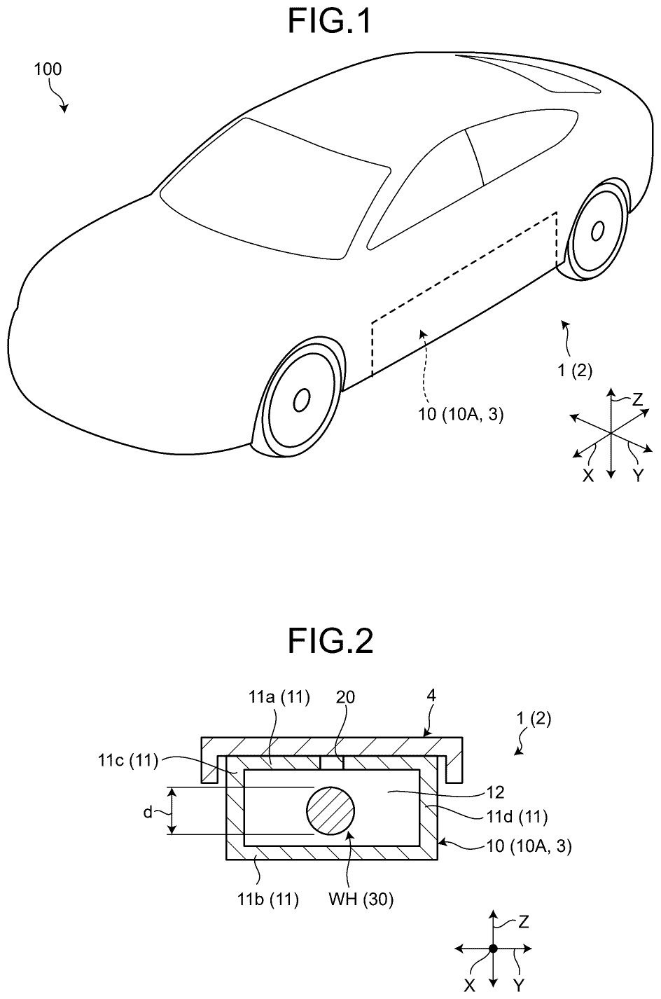

FIG. 1 is a perspective view of a vehicle 100 to which a wire harness assembly 1 according to an embodiment is applied, and FIG. 2 is a cross-sectional view of the wire harness assembly 1 to which a jig 5 according to the embodiment is applied. The wire harness assembly 1 of the present embodiment illustrated in FIGS. 1 and 2 is applied to the vehicle 100 such as an automobile, and is used for power supply and signal communication by connecting devices mounted on the vehicle 100. The wire harness assembly 1 of the present embodiment includes, for example, the wire harness WH, an attachment member 10A having a predetermined rigidity and provided with a routing space portion 12 in which the wire harness WH is routed, and a slit 20 that is provided in an outer wall 11 of the attachment member 10A and enables insertion of the wire harness WH into the routing space portion 12 from the outside. The wire harness WH is configured to include an electric wire bundle 30 (see FIG. 5) in which a plurality of electric wires W having conductivity is bundled. Note that the wire harness assembly 1 may be configured to further include a connector, a corrugated tube, a grommet, a fixture, and the like.

Here, in the present embodiment, the attachment member 10A includes a body member 10 constituting a framework of the vehicle 100. The body member 10 is, for example, a cylindrical rocker constituting a side sill 3 of the vehicle 100, and is mounted on the vehicle 100 in a state where both end portions of the routing space portion 12 in an axial direction X are closed. Then, in the present embodiment, the wire harness WH is inserted into and routed in the routing space portion 12 as an internal space portion of the body member 10 through the slit 20. As a result, for example, as compared with the case where the wire harness WH is routed between the body member 10 and a scuff plate 4, the position of the scuff plate 4 can be set lower, and eventually, the opening area of the entrance/exit of the vehicle 100 can be expanded, and the passenger can more smoothly get on and off. The slit 20 is installed in the vehicle 100 in a state of being covered by the scuff plate 4, for example.

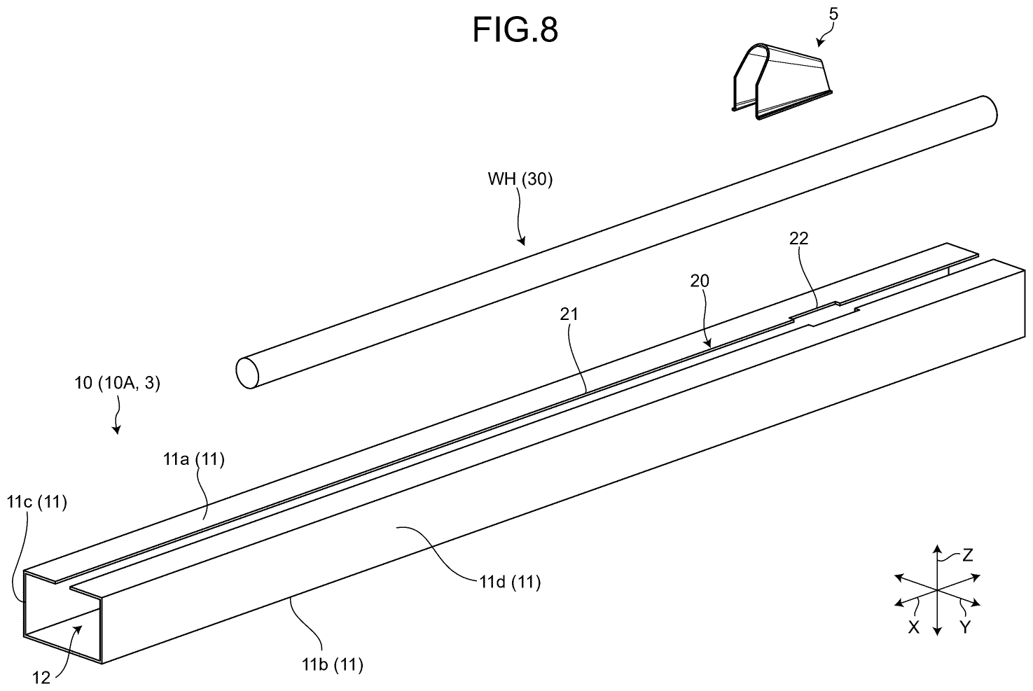

Note that, in the description below, among a first direction, a second direction, and a third direction intersecting one another, the first direction is referred to as an “axial direction X”, the second direction is referred to as a “width direction Y”, and the third direction is referred to as a “height direction Z”. Here, the axial direction X, the width direction Y, and the height direction Z are substantially orthogonal to one another. The axial direction X typically corresponds to the extending direction of the wire harness WH, the longitudinal direction of the body member 10 (attachment member 10A), or the like, and is along a vehicle front-rear direction. The width direction Y typically corresponds to a width direction (left-right direction) of the body member 10 (attachment member 10A) or the like, and is along a vehicle width direction. The height direction Z typically corresponds to a height direction (up-down direction) of the body member 10 (attachment member 10A) or the like, and is along a vehicle up-down direction. In addition, each direction used in the description below will be described as a direction in a state where the wire harness assembly 1 is assembled to the vehicle 100 unless otherwise specified. Note that, in FIGS. 2, 8, and the like, the illustration of the plurality of electric wires W constituting the electric wire bundle 30 is simplified for convenience.

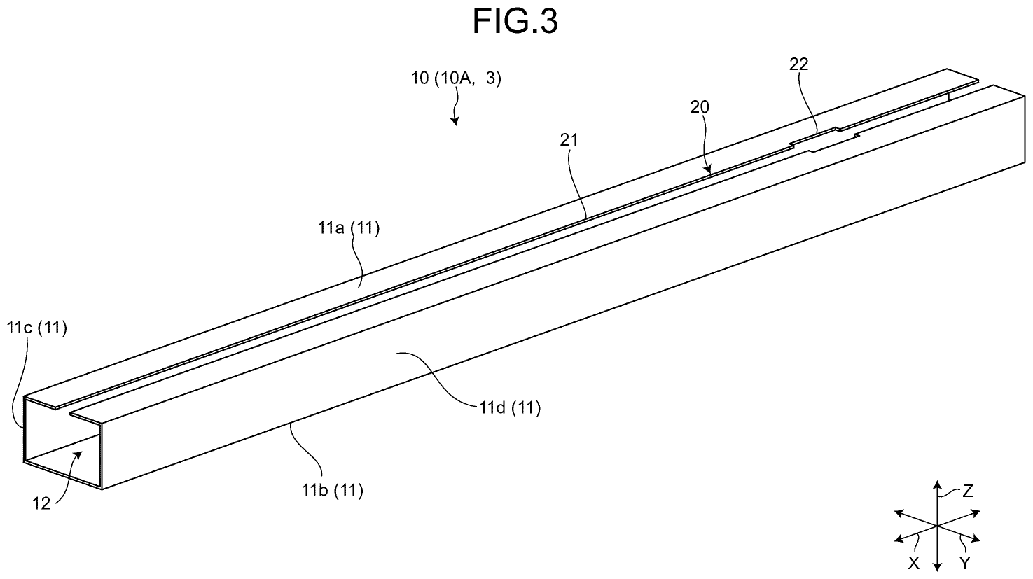

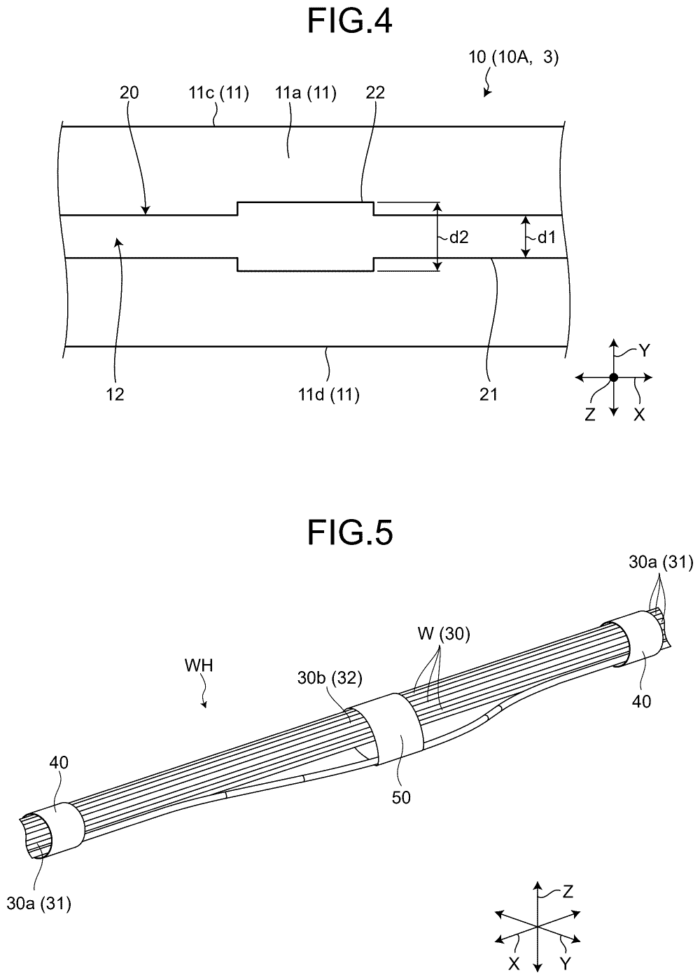

FIG. 3 is a perspective view of the body member 10 of the wire harness assembly 1, and FIG. 4 is a plan view of the vicinity of a wide portion 22 of the slit 20 of the wire harness assembly 1. As illustrated in FIGS. 3 and 4, the body member 10 is made of, for example, an extruded material of a metal material, and has the outer wall 11 having a rectangular cylindrical cross-sectional shape intersecting the axial direction X. The outer wall 11 is a structural body for partitioning the above-described routing space portion 12 as an internal space portion of the body member 10. The routing space portion 12 is a space portion through which the electric wire bundle 30 of the wire harness WH is inserted and routed. The outer wall 11 is configured to include, for example, an upper wall 11a, a lower wall 11b, and a pair of side walls 11c and 11d.

The upper wall 11a and the lower wall 11b both extend along a direction orthogonal to the height direction Z, and are provided in parallel to each other at an interval in the height direction Z. The upper wall 11a constitutes an upper end portion of the body member 10, and the lower wall 11b constitutes a lower end portion of the body member 10. The upper wall 11a faces a vehicle interior space of the vehicle 100, and the lower wall 11b faces a floor of the vehicle 100. The upper wall 11a and the lower wall 11b are formed in a flat plate shape extending horizontally along the axial direction X.

The pair of side walls 11c and 11d both extend along a direction orthogonal to the width direction Y, and are provided in parallel to each other at an interval in the width direction Y. The side wall 11c extends between one end portions of the upper wall 11a and the lower wall 11b in the width direction Y and constitutes a right end portion of the body member 10. The side wall 11d extends between the other end portions of the upper wall 11a and the lower wall 11b in the width direction Y and constitutes a left end portion of the body member 10. The side wall 11c faces the vehicle interior space of the vehicle 100, and the side wall 11d faces a frame or the like of the vehicle 100. The pair of side walls 11c and 11d is formed in a flat plate shape extending horizontally along the axial direction X.

Here, in the present embodiment, among the upper wall 11a, the lower wall 11b, and the pair of side walls 11c and 11d constituting the outer wall 11, for example, the upper wall 11a facing the vehicle interior space is provided with the slit 20 extending along the axial direction X. The upper wall 11a is a partition wall that separates the routing space portion 12 of the body member 10 and the vehicle interior space. The routing space portion 12 is an internal space portion of the body member 10, and the vehicle interior space is an external space portion of the body member 10. The slit 20 is a through hole penetrating the upper wall 11a along the height direction Z, and communicates the routing space portion 12 of the body member 10 with the vehicle interior space. As a result, the electric wire bundle 30 of the wire harness WH can be inserted into the routing space portion 12 from the vehicle interior space side through the slit 20. In the present embodiment, the upper wall 11a is an example of a first wall portion.

In addition, the slit 20 is configured to include, for example, a narrow portion 21 and the wide portion 22. The narrow portion 21 has an opening width d1 formed to be narrower than an outer diameter d (see FIG. 2) of the electric wire bundle 30, and the wide portion 22 has an opening width d2 formed to be wider than the outer diameter d of the electric wire bundle 30. The opening width d1 is an opening width of the narrow portion 21 along the width direction Y, and the opening width d2 is an opening width of the wide portion 22 along the width direction Y. In the present embodiment, the narrow portion 21 is provided across one end portion and the other end portion of the upper wall 11a in the axial direction X, and penetrates the upper wall 11a along the axial direction X. The wide portion 22 is partially provided on the other end portion side of the narrow portion 21 in the axial direction X and communicates with the narrow portion 21. The wide portion 22 functions as, for example, an inlet opening for inserting a jig 5 (see FIGS. 8 to 10) to be described below into the slit 20.

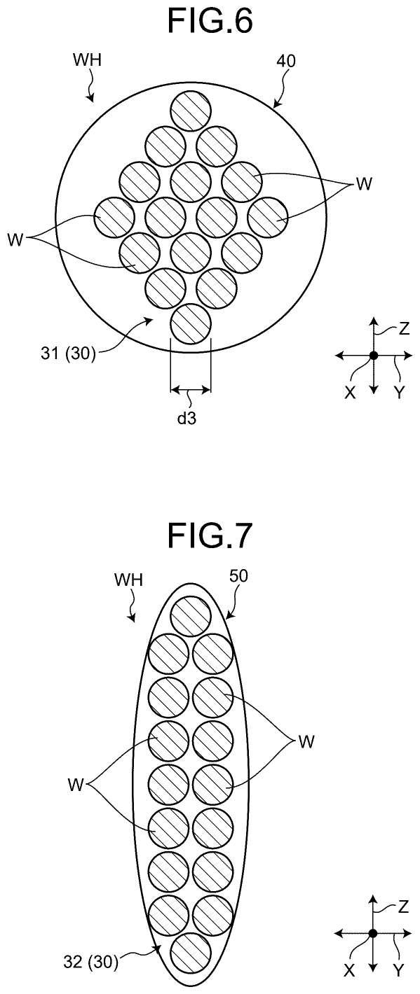

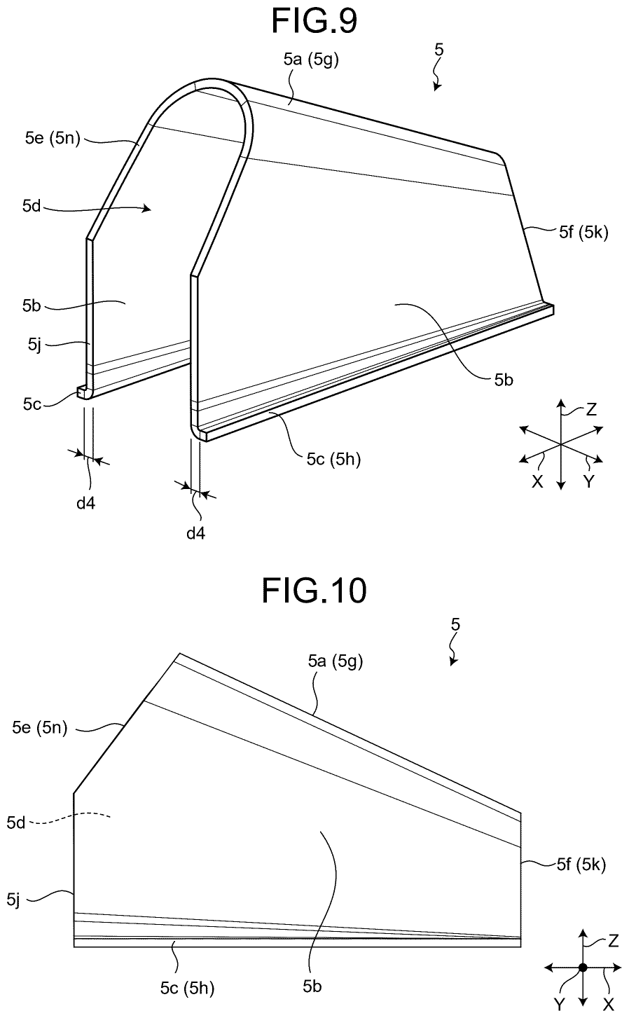

In addition, in the present embodiment, the opening width d1 of the narrow portion 21 is at least formed to be wider than the sum of an outer diameter d3 (see FIG. 6) of one electric wire W having the maximum outer diameter among the plurality of electric wires W constituting the electric wire bundle 30 and a plate thickness d4 (see FIG. 9) of a pair of side walls 5b of the jig 5 that inserts the electric wire bundle 30 into the routing space portion 12 through the slit 20. Specifically, in the present embodiment, the plurality of electric wires W is configured to have outer diameters equivalent to each other, and the opening width d1 of the narrow portion 21 is set to a total width of outer diameters d3 of about two or three of the plurality of electric wires W. Note that, in the present embodiment, the case where the plurality of electric wires W is configured to have outer diameters equivalent to each other has been exemplified, but it is not limited to this example, and for example, at least one of the plurality of electric wires W may be configured to have a different outer diameter with respect to the other electric wires W.

In addition, in the present embodiment, the case where the slit 20 is configured to include the narrow portion 21 and the wide portion 22 has been exemplified, but it is not limited to this example, and for example, the slit may be configured to include only the narrow portion 21 without the wide portion 22. In addition, in the present embodiment, the case where the slit 20 is provided across the one end portion and the other end portion of the upper wall 11a in the axial direction X has been exemplified, but it is not limited to this example, and for example, the slit may be partially provided at an intermediate position between the one end portion and the other end portion of the upper wall 11a in the axial direction X. In addition, in the present embodiment, the case where the body member 10 has a rectangular cylindrical cross-sectional shape and the routing space portion 12 is configured to be closed as an internal space portion has been exemplified, but it is not limited to this example, and for example, the body member 10 may be formed to have a substantially U-shaped cross-sectional shape and the routing space portion 12 may not be closed, and furthermore, in this case, the routing space portion 12 may be closed by another member different from the body member 10.

FIG. 5 is a perspective view of the wire harness WH, FIG. 6 is a cross-sectional view of a binding posture maintaining portion 31 of the wire harness WH, and FIG. 7 is a cross-sectional view of a binding posture variable portion 32 of the wire harness WH. As illustrated in FIGS. 5 to 7, the wire harness WH includes, for example, the electric wire bundle 30 in which the plurality of electric wires W is bundled. The electric wire W is configured to include a core wire and an insulating sheath covering the core wire. The electric wires W extend linearly along the axial direction X and are formed to extend with substantially the same diameter with respect to the axial direction X (extending direction). In addition, in the electric wire W, for example, the cross-sectional shape of the core wire (cross-sectional shape intersecting the axial direction X) is formed in a substantially circular shape, and the cross-sectional shape of the insulating sheath is formed in a substantially annular shape, and the electric wire W is formed in a substantially circular cross-sectional shape as a whole.

In addition, the electric wire bundle 30 is configured to include, for example, a pair of binding posture maintaining portions 31 and the binding posture variable portion 32. The pair of binding posture maintaining portions 31 is portions located at both end portions 30a of the electric wire bundle 30 in the axial direction X and bound to maintain the binding posture. In the present embodiment, a first binding member 40 that binds the plurality of electric wires W is provided in each of the pair of binding posture maintaining portions 31. The pair of first binding members 40 may be, for example, a binding member such as a binding band, a tape member such as an adhesive tape, or other members. The first binding member 40 binds the plurality of electric wires W so as to maintain the binding posture of the electric wire bundle 30, in other words, the cross-sectional shape (see FIG. 6) of the electric wire bundle 30 intersecting the axial direction X.

For example, the first binding member 40 goes around the plurality of electric wires W at the same position in the axial direction X of the electric wire bundle 30. That is, the first binding member 40 is wound around the plurality of electric wires W such that a portion located on the inner side and a portion overlapping the outer side are at the same location in the axial direction X in the overlapping portion. In the electric wire bundle 30, the plurality of electric wires W is exposed in a section between one and the other of the pair of first binding members 40. Note that, in the present embodiment, the case where the first binding member 40 is formed by circling around the plurality of electric wires W at the same location of the electric wire bundle 30 in the axial direction X has been exemplified, but it is not limited to this example, and for example, the first binding member 40 may be formed by being spirally wound around the plurality of electric wires W at different locations of the electric wire bundle 30 in the axial direction X.

The binding posture variable portion 32 is a portion that is located between the pair of binding posture maintaining portions 31 of the electric wire bundle 30 in the axial direction X and at which the binding posture is variable. In the present embodiment, the binding posture variable portion 32 is provided with a second binding member 50 that more loosely binds the plurality of electric wires W than the first binding member 40. The second binding member 50 is provided, for example, at a central portion 30b of the electric wire bundle 30 in the axial direction X. The second binding member 50 may be, for example, a binding member such as a binding band, a tape member such as an adhesive tape, or other members. The second binding member 50 binds the plurality of electric wires W so that the binding posture of the electric wire bundle 30, in other words, the cross-sectional shape (see FIG. 7) of the electric wire bundle 30 intersecting the axial direction X becomes variable.

The second binding member 50 has, for example, an inner diameter larger than the outer diameter d (see FIG. 2) of the electric wire bundle 30, and is configured to be capable of accommodating displacement of the electric wire bundle 30 along a radial direction. That is, the second binding member 50 is wound around the plurality of electric wires W so that the plurality of electric wires W can move relative to each other so as to be unraveled. For example, the second binding member 50 may be formed by circling around the plurality of electric wires W at the same location of the electric wire bundle 30 in the axial direction X, and the second binding member 50 may be formed by being spirally wound around the plurality of electric wires W at different locations of the electric wire bundle 30 in the axial direction X. In the electric wire bundle 30, the plurality of electric wires W is exposed in a section between the second binding member 50 and the pair of first binding members 40 described above.

Note that, in the present embodiment, the case where the plurality of electric wires W is bound by the second binding member 50 of the binding posture variable portion 32 has been exemplified, but it is not limited to this example, and for example, the second binding member 50 may not be provided and the plurality of electric wires W may not be bound. That is, the binding posture variable portion 32 also includes a form in which the binding member itself such as the second binding member 50 does not exist. The binding posture variable portion 32 is also referred to as a cross-sectional shape variable portion or the like, and the binding posture maintaining portion 31 is also referred to as a cross-sectional shape maintaining portion or the like.

FIG. 8 is an exploded perspective view of the wire harness assembly 1, FIG. 9 is a perspective view of the jig 5, and FIG. 10 is a side view of the jig 5. As illustrated in FIGS. 8 to 10, the jig 5 is used, for example, when the electric wire bundle 30 of the wire harness WH is inserted into the routing space portion 12 of the body member 10 through the slit 20. The jig 5 is formed of, for example, a flexible member having flexibility such as synthetic resin, and is configured to include a bottom wall 5a, the pair of side walls 5b, a pair of flange walls 5c, a first cut portion 5f, and a second cut portion 5e.

The pair of side walls 5b is portions of the jig 5 that hold the electric wire bundle 30 from both sides in the width direction Y. The pair of side walls 5b both extend along a direction orthogonal to the width direction Y, and are provided in parallel to each other at an interval in the width direction Y. One of the pair of side walls 5b constitutes a right end portion of the jig 5, and the other of the pair of side walls 5b constitutes a left end portion of the jig 5. The pair of side walls 5b is formed in a flat plate shape extending horizontally along the axial direction X.

The bottom wall 5a is a portion that extends in an arc shape along an outer peripheral surface of the electric wire bundle 30 and couples one end portions 5g of the pair of side walls 5b in the height direction Z. The bottom wall 5a has a substantially U-shaped cross section opened toward the other side in the height direction Z. The bottom wall 5a constitutes an upper end portion of the jig 5, and holds the electric wire bundle 30 from one side in the height direction Z. In the present embodiment, the bottom wall 5a and the pair of side walls 5b are formed in a tapered shape in which the bottom wall 5a is inclined so as to gradually approach the other end portions 5h of the pair of side walls 5b in the height direction Z from the one end portion 5j side toward the other end portion 5k side in the axial direction X. Accordingly, the insertability of the electric wire bundle 30 into the slit 20 is enhanced. That is, the bottom wall 5a functions as a guide when the electric wire bundle 30 is inserted into the slit 20.

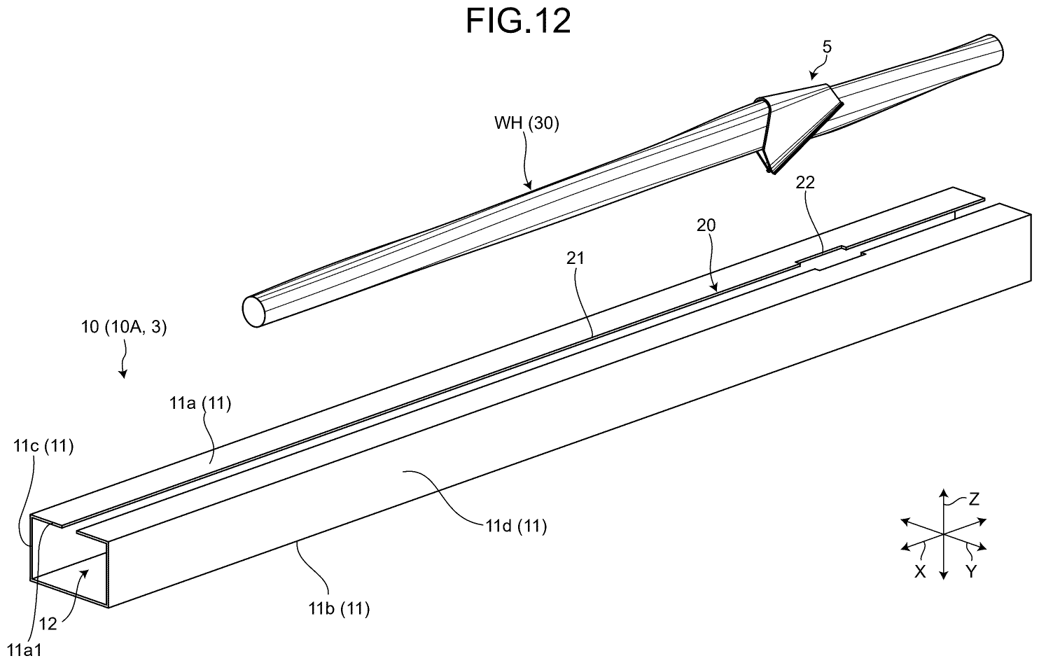

The pair of flange walls 5c is portions that are provided at the other end portions 5h of the pair of side walls 5b in the height direction Z and protrude from the other end portions 5h toward the sides where they are separated from each other along the width direction Y. The pair of flange walls 5c is slidably locked to a peripheral edge portion of the slit 20 on an inner surface 11a1 (see FIG. 12) on the routing space portion 12 side of the upper wall 11a. The pair of flange walls 5c extends in parallel with the upper wall 11a. The protrusion amount of the pair of flange walls 5c along the width direction Y is appropriately set according to the opening widths d1 and d2 of the slit 20, and the like.

The first cut portion 5f is a portion that is provided on the other end portion 5k side of the bottom wall 5a and the pair of side walls 5b in the axial direction X, and extends along the height direction Z across the bottom wall 5a and the other end portions 5h of the pair of side walls 5b when viewed from the width direction Y (see FIG. 10). The first cut portion 5f has a flat end surface facing the other side in the axial direction X. The first cut portion 5f is formed, for example, by cutting or the like the other end portion 5k of the bottom wall 5a and the pair of side walls 5b in the axial direction X along the height direction Z. The first cut portion 5f is perpendicular to the pair of flange walls 5c. The first cut portion 5f functions as, for example, a portion that suppresses catching of the jig 5 at the time of insertion into the slit 20.

The second cut portion 5e is a portion that is provided on the one end portion 5j side of the bottom wall 5a and the pair of side walls 5b in the axial direction X, and extends along an inclination direction between the height direction Z and the axial direction X across the bottom wall 5a and the one end portions 5j of the pair of side walls 5b when viewed from the width direction Y (see FIG. 10). The second cut portion 5e is provided at a corner portion 5n where the bottom wall 5a and the pair of side walls 5b intersect on the one end portion 5j side in the axial direction X. The second cut portion 5e has a flat end surface facing one side in the axial direction X and one side in the height direction Z. The second cut portion 5e is formed, for example, by cutting or the like the corner portion 5n of the bottom wall 5a and the pair of side walls 5b along the inclination direction between the height direction Z and the axial direction X. The second cut portion 5e is inclined with respect to the pair of flange walls 5c, the first cut portion 5f, and the like. The second cut portion 5e functions as, for example, a portion that suppresses catching of the jig 5 at the time of insertion into the slit 20.

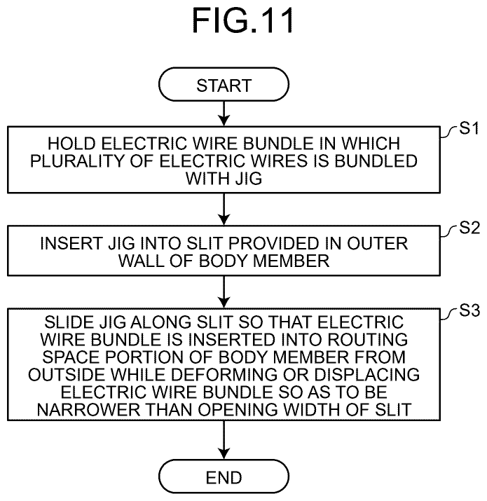

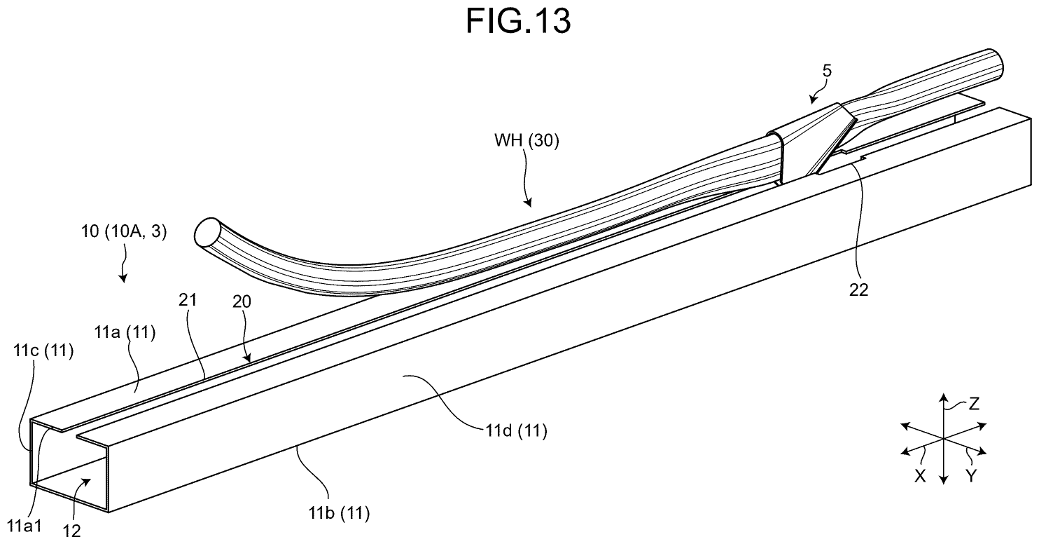

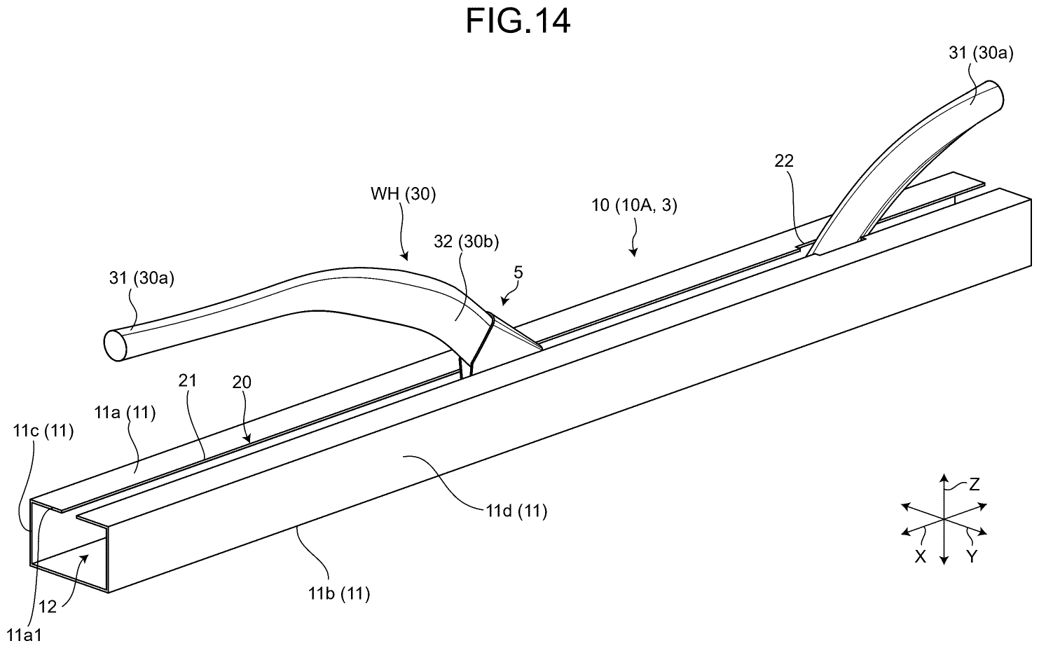

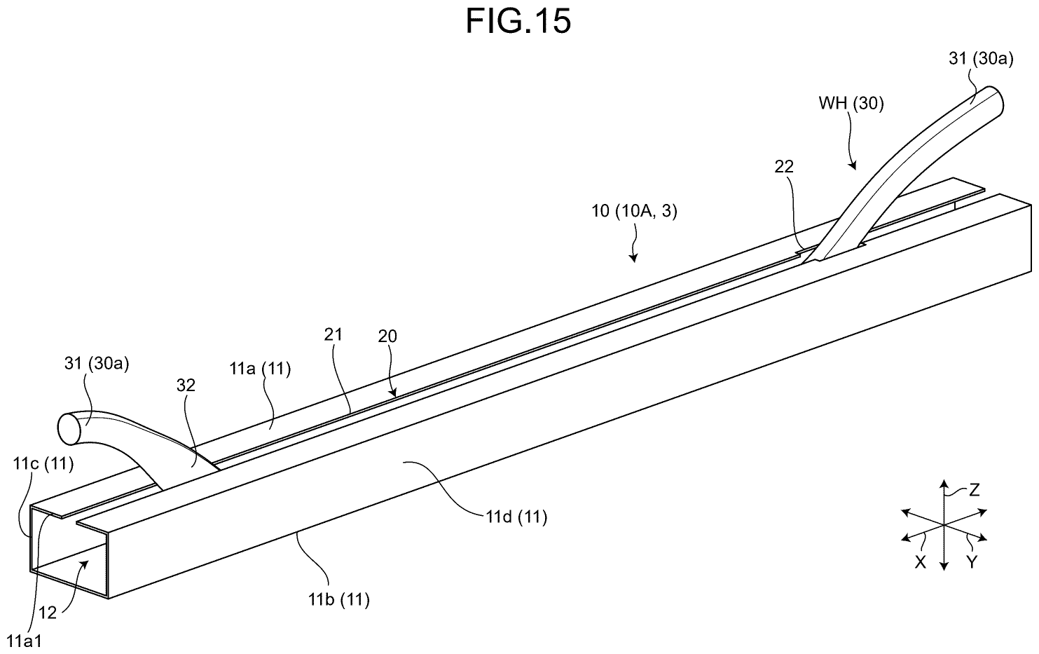

Next, an example of a method for manufacturing the wire harness assembly 1 having the above configuration will be described. FIG. 11 is a flowchart of a method for manufacturing the wire harness assembly 1, FIG. 12 is a perspective view of the wire harness assembly 1 and is a view illustrating a first step S1, FIG. 13 is a perspective view of the wire harness assembly 1 and is a view illustrating a second step S2, FIG. 14 is a perspective view of the wire harness assembly 1 and is a view illustrating a third step S3, and FIG. 15 is a perspective view of the wire harness assembly 1 and is a view illustrating a fourth step S4.

First, in the process of the first step S1, as illustrated in FIGS. 11 and 12, the electric wire bundle 30 in which the plurality of electric wires W is bundled is held with the jig 5. In this case, the above-described binding posture variable portion 32 of the electric wire bundle 30 is held from both sides in the width direction Y by the pair of side walls 5b of the jig 5, and the binding posture variable portion 32 is deformed or displaced so as to be in a vertically long state along the height direction Z. In addition, the jig 5 is inclined such that the bottom wall 5a of the jig 5 is parallel to the electric wire bundle 30 (axial direction X). In this case, the jig 5 is inclined such that the one end portion 5j in the axial direction X approaches the slit 20 located on the other side in the height direction Z with respect to the other end portion 5k.

Next, in the process of the second step S2, as illustrated in FIGS. 11 and 13, the jig 5 is inserted into the slit 20 provided in the outer wall 11 of the body member 10 (attachment member 10A). In this case, for example, the jig 5 is inserted into the wide portion 22 of the slit 20 and is obliquely inserted with respect to the wide portion 22. At this time, in the present embodiment, since the above-described second cut portion 5e is provided at the one end portion 5j of the jig 5 in the axial direction X, the one end portion 5j of the jig 5 in the axial direction X is suppressed from being caught by an edge portion of the wide portion 22 by the second cut portion 5e. Then, the jig 5 obliquely inserted into the wide portion 22 is pushed toward one side in the axial direction X, and the posture of the jig 5 is returned so that the pair of flange walls 5c of the jig 5 is parallel to the upper wall 11a. At this time, in the present embodiment, since the above-described first cut portion 5f is provided at the other end portion 5k of the jig 5 in the axial direction X, the other end portion 5k of the jig 5 in the axial direction X is suppressed from being caught by the edge portion of the wide portion 22 by the first cut portion 5f.

Next, in the process of the third step S3, as illustrated in FIGS. 11 and 14, by sliding the jig 5 along the narrow portion 21 of the slit 20, the electric wire bundle 30 is inserted into the routing space portion 12 of the body member 10 from the outside while deforming or displacing the electric wire bundle 30 so as to be narrower than the opening width d1 of the slit 20. In this case, the pair of flange walls 5c of the jig 5 is slidably locked to the peripheral edge portion of the slit 20 on the inner surface 11a1 of the upper wall 11a. The binding posture variable portion 32 of the electric wire bundle 30 is guided to the slit 20 side by the bottom wall 5a of the jig 5, and the binding posture variable portion 32 falls through an opening 5d between the pair of side walls 5b to the routing space portion 12 through the slit 20 as a result of the sliding movement of the jig 5 toward one side in the axial direction X with respect to the upper wall 11a.

Then, in the process of the fourth step S4, as illustrated in FIGS. 11 and 15, the jig 5 is removed from the slit 20. In this case, the jig 5 is pulled out obliquely with respect to the narrow portion 21 of the slit 20, for example. In a state where the electric wire bundle 30 is assembled to the body member 10, the binding posture variable portion 32 at the central portion 30b in the axial direction X is routed in the routing space portion 12, and the pair of binding posture maintaining portions 31 at both end portions 30a in the axial direction X is drawn out to the outside of the body member 10 through the slit 20. Through the first step S1 to the fourth step S4, the electric wire bundle 30 of the wire harness WH can be assembled to the routing space portion 12 of the body member 10 to manufacture the wire harness assembly 1. Note that the jig 5 is not limited to be used in a direction along a vertical direction (height direction Z) as illustrated in FIGS. 9, 12, and the like, and may be used, for example, in a direction of being laid down in a horizontal direction (width direction Y or axial direction X).

As described above, in the jig 5 of the present embodiment, the bottom wall 5a and the pair of side walls 5b are formed in a tapered shape in which the bottom wall 5a is inclined so as to gradually approach the other end portions 5h of the pair of side walls 5b in the height direction Z from the one end portion 5j side to the other end portion 5k side in the axial direction X, and the first cut portion 5f extending along the height direction Z across the bottom wall 5a and the other end portions 5h of the pair of side walls 5b in the height direction Z as viewed from the width direction Y is provided on the other end portion 5k side in the axial direction X. With this configuration, with the jig 5, for example, the other end portions 5k of the bottom wall 5a and the pair of side walls 5b in the axial direction X can be suppressed from being caught by the slit 20 of the body member 10 (attachment member 10A) by the first cut portion 5f. As a result, the jig 5 can improve the workability of attachment work.

In addition, in the jig 5 of the present embodiment, the pair of side walls 5b includes the pair of flange walls 5c provided at the other end portions 5h in the height direction Z, protruding toward the sides where the pair of flange walls 5c are separated from each other along the width direction Y, and slidably locked to the inner surface 11a1 of the outer wall 11 on the routing space portion 12 side. With this configuration, in the jig 5, for example, the jig 5 can be slid with respect to the inner surface 11a1 of the outer wall 11 by the pair of flange walls 5c, and the workability of the attachment work of the electric wire bundle 30 can be further improved.

In addition, in the jig 5 of the present embodiment, the bottom wall 5a and the pair of side walls 5b are configured to include the second cut portion 5e provided at the corner portion 5n where the bottom wall 5a and the pair of side walls 5b intersect on the one end portion 5j side in the axial direction X, and extending along the inclination direction between the height direction Z and the axial direction X across the bottom wall 5a and the one end portions 5j of the pair of side walls 5b in the axial direction X when viewed from the width direction Y. With this configuration, the jig 5 can suppress the one end portion 5j side of the jig 5 in the axial direction X from being caught with respect to the slit 20 by the second cut portion 5e, for example, and the workability of the attachment work can be further improved.

### Modification

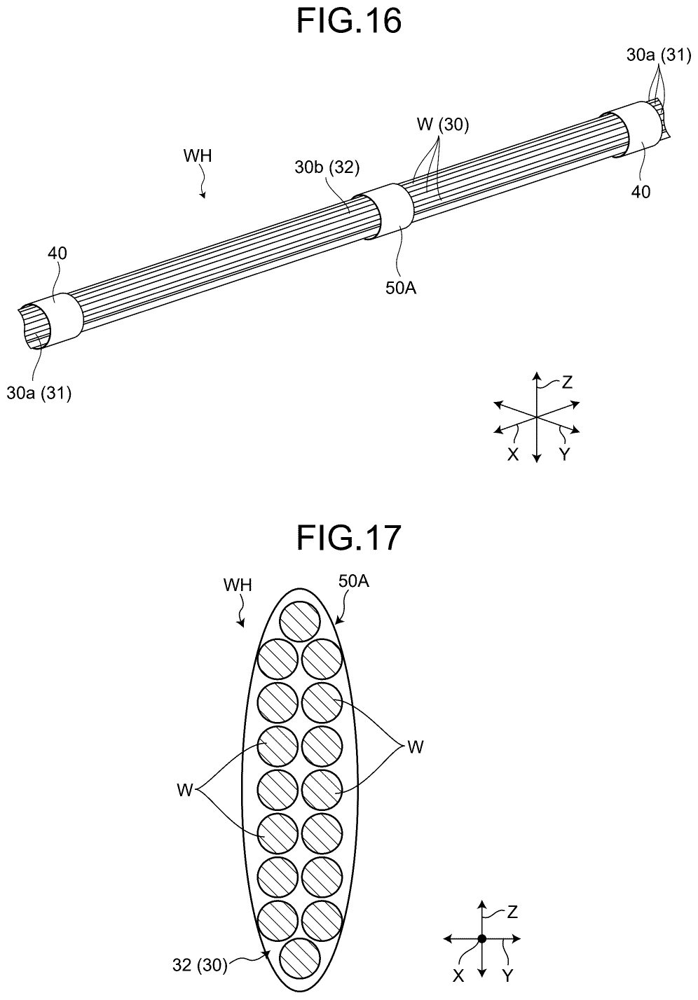

FIG. 16 is a perspective view of the wire harness WH according to a modification, and FIG. 17 is a cross-sectional view of the binding posture variable portion 32 of the wire harness WH according to the modification. The wire harness WH illustrated in FIGS. 16 and 17 has the same configuration as the wire harness WH of the above embodiment. Therefore, the wire harness WH can obtain the same operations and effects as those of the above embodiment based on the same configuration.

However, as illustrated in FIGS. 16 and 17, the present modification is different from the above embodiment in that a second binding member 50A includes a binding band or the like having elasticity. Specifically, in the present modification, the second binding member 50A binds the plurality of electric wires W more loosely than the first binding member 40, and is provided at the central portion 30b of the electric wire bundle 30 in the axial direction X. The second binding member 50A binds the plurality of electric wires W so that the binding posture of the electric wire bundle 30, in other words, the cross-sectional shape (see FIG. 17) intersecting the axial direction X of the electric wire bundle 30 becomes variable.

The second binding member 50A has, for example, an inner diameter equivalent to the outer diameter d (see FIG. 2) of the electric wire bundle 30, and is configured to be capable of accommodating deformation of the electric wire bundle 30 along a radial direction. That is, the second binding member 50A is wound around the plurality of electric wires W in a state where the electric wire bundle 30 can be elastically deformed. Note that FIG. 17 illustrates a cross-sectional shape at the time of insertion (at the time of elastic deformation) of the binding posture variable portion 32 bound by the second binding member 50A with respect to the slit 20.

As described above, in the wire harness WH of the present modification, the second binding member 50A has the inner diameter equivalent to the outer diameter d of the electric wire bundle 30, and is configured to be able to accommodate the deformation of the electric wire bundle 30 along the radial direction. With this configuration, with the wire harness WH, for example, the deformation, displacement, and the like of the electric wire bundle 30 can be accommodated by the second binding member 50A, and eventually the workability of the attachment work of the wire harness WH can be improved.

Note that, in the above embodiment and modification, the case where the attachment member 10A includes the body member 10 constituting the framework of the vehicle 100 has been exemplified, but it is not limited to this example, and for example, the attachment member may include a metal exterior material that regulates the routing path of the electric wire bundle 30. In addition, in the above embodiment and modification, the case where the slit 20 is provided in the upper wall 11a of the body member 10 (attachment member 10A) has been exemplified, but it is not limited to this example, and for example, the slit may be provided in the side wall 11c located on the vehicle interior space side of the pair of side walls 11c and 11d. In this case, the side wall 11c is an example of the first wall portion.

In addition, in the above embodiment and the above modification, the case where the slit 20 is provided to extend along the axial direction X with respect to the outer wall 11 of the body member 10 has been exemplified, but it is not limited to this example, and for example, the slit 20 may be configured to include a first portion extending along the axial direction X and a second portion communicating with the first portion and extending along the width direction Y. In this case, for example, by providing the second portion across the upper wall 11a and the side wall 11c on the vehicle interior space side of the outer wall 11, the binding posture maintaining portion 31 of the electric wire bundle 30 can be drawn out from the side wall 11c.

Although the embodiment and the modification of the present invention have been exemplified above, the above embodiment and modification are examples, and are not intended to limit the scope of the invention. The above embodiment and modification can be implemented in various other forms, and various omissions, substitutions, combinations, and changes can be made without departing from the gist of the invention. In addition, specs (structure, type, direction, form, size, length, width, thickness, height, number, arrangement, position, material, and the like) of each configuration, shape, and the like can be appropriately changed and implemented.

In the jig according to the present embodiment, a bottom wall and a pair of side walls are formed in a tapered shape in which the bottom wall is inclined so as to gradually approach the other end portions of the pair of side walls in a height direction from one end portion side to the other end portion side in an axial direction, and a first cut portion extending along the height direction across the bottom wall and the other end portions of the pair of side walls in the height direction as viewed from a width direction is provided on the other end portion side in the axial direction. With this configuration, with the jig, for example, the other end portions of the bottom wall and the pair of side walls in the axial direction can be suppressed from being caught by the slit of the attachment member by the first cut portion. As a result, the jig provides the effect that workability of attachment work can be improved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A jig comprising:
a pair of side walls that holds an electric wire bundle in which a plurality of electric wires extending along an axial direction is bundled from both sides in a width direction intersecting the axial direction; and
a bottom wall that extends in an arc shape along an outer peripheral surface of the electric wire bundle and couples one end portions of the pair of side walls in a height direction intersecting the axial direction and the width direction, wherein
the pair of side walls is configured such that other end portions in the height direction can be inserted into a routing space portion of an attachment member through a slit provided in an outer wall of the attachment member, and
the bottom wall and the pair of side walls are formed in a tapered shape in which the bottom wall is inclined so as to gradually approach the other end portions of the pair of side walls in the height direction from one end portion side to an other end portion side in the axial direction, and a first cut portion extending along the height direction across the bottom wall and the other end portions of the pair of side walls in the height direction as viewed from the width direction is provided on the other end portion side in the axial direction.

2. The jig according to claim 1, wherein
the pair of side walls includes a pair of flange walls provided at the other end portions in the height direction, protruding toward sides where the pair of flange walls are separated from each other along the width direction, and slidably locked to an inner surface of the outer wall on a routing space portion side.

3. The jig according to claim 1, wherein
the bottom wall and the pair of side walls are configured to include a second cut portion provided at a corner portion where the bottom wall and the pair of side walls intersect on the one end portion side in the axial direction, and extending along an inclination direction between the height direction and the axial direction across the bottom wall and the one end portions of the pair of side walls in the axial direction when viewed from the width direction.

4. The jig according to claim 2, wherein
the bottom wall and the pair of side walls are configured to include a second cut portion provided at a corner portion where the bottom wall and the pair of side walls intersect on the one end portion side in the axial direction, and extending along an inclination direction between the height direction and the axial direction across the bottom wall and the one end portions of the pair of side walls in the axial direction when viewed from the width direction.
